(19) United States
(12) Patent Application Publication
(10) Pub. No.: US 2007/0081673 A1
(43) Pub. Date: Apr. 12, 2007

(54) CCM encryption/decryption engine

(75) Inventor: Jing-Fei Ren, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/246,998

(22) Filed: Oct. 7, 2005

(51) Int. Cl. H04K 1/00

(52) U.S. Cl. 380/270

(57) ABSTRACT

A system 10 for processing data packets according to a CCMP protocol is provided. The system includes a software component 40 operable to form a nonce and an MD according to a CCMP protocol. The system includes a hardware component 20 operable to receive the nonce and AAD and encrypt a portion of the data packet and calculate a MIC according to the CCMP protocol.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure is directed to data communication, and more particularly, but not by way of limitation, to a system and method for encrypting and decrypting data in wireless data transmissions.

### BACKGROUND OF THE INVENTION

Wireless data transmissions may be structured as packets consisting of a payload and a header. The payload contains the information to be conveyed while the header typically contains security data and other metadata such as the packet length, the data transmission rate, and the communication means. A transmitter may transmit the packets to a plurality of wireless receivers in a wireless network. Each receiver may read the metadata in a packet to determine how the packet is to be processed.

Security measures, such as the Counter Mode with Cipher Block Chaining Message Authentication Code Protocol, or CCMP, are typically applied to the packets to prevent unauthorized access to the data. CCMP is a National Institute of Standards and Technology (NIST) standard dealing with two aspects of data security. A data encryption and decryption portion follows the NIST Advanced Encryption Standard to ensure that the payload is properly encrypted and decrypted.

The other aspect of CCMP concerns authentication of a data transmission. When a transmitter prepares a packet to be sent, a code is generated based on the data in the packet and additional information using the NIST Advanced Encryption Standard. The code is then attached to the encrypted packet. This code, known as a message integrity code or MIC, is unique for each packet. Upon receiving a packet, a receiver calculates a MIC using the same algorithm used by the transmitter. If the calculated MIC matches the received MIC, it can be assumed that the data transmission was not tampered with.

The data used in calculating the MIC includes the payload data and fields formatted from the information in the header and some additional parameters known as the nonce and the additional authentication data blocks (AADs). The nonce encodes the system dependent parameters and a unique packet number counter used only one time during the lifetime of the security key to place a unique marker on the MIC. The AADs are 128-bit data blocks that might be placed in a header to provide additional system-dependent information.

Many of the standards for wireless data transmission, such as IEEE 802.11, IEEE 802.15, IEEE 802.16, and ultra wideband (UWB), use the CCMP protocol for data security, but each standard might implement CCMP differently. In particular, the methods of forming the nonce and the AADs and then using the nonce, the AADs, and the payload data to generate the MIC are generally different from standard to standard.

### SUMMARY OF THE INVENTION

In one embodiment, a system for processing data packets according to a CCMP protocol is provided. The system includes a software component operable to form a nonce and AADs according to a CCMP protocol. The system includes a hardware component operable to receive the nonce and AADs from the software component and encrypt a portion of the data packet according to the CCMP protocol.

In another embodiment, a system for processing a data packet according to a CCMP protocol is provided. The system includes a RISC processor, a CCMP coprocessor, a data RAM, and an instruction RAM. The RISC processor is operable to form a nonce and one or more AADs according to the supported wireless standard. The CCMP coprocessor encrypts at least a portion of the data packet according to a CCMP protocol. The CCMP coprocessor generates a message integrity code based at least partially on the nonce and the AADs, and further provides the message integrity code with the encrypted portion of the data packet. The data RAM component stores the data packet and the instruction RAM component stores instructions used by the RISC processor for forming the nonce and the AADs.

In another embodiment, a method for preparing a data packet for wireless transmission according to a CCMP protocol is provided. The method includes moving a header portion of the data packet from a data RAM component to a RISC processor. The method includes moving a payload portion of the data packet from the data RAM component to a CCMP coprocessor. The method includes encrypting the payload by the CCMP coprocessor according to the CCMP protocol. The method includes the RISC processor using instructions to form a nonce and AADs according to the CCMP protocol. The method includes sending the nonce and the AADs from the RISC processor to the CCMP coprocessor. The method includes generating a message integrity code by the CCMP coprocessor based at least partially on the nonce and the AADs. The method includes attaching the message integrity code to the encrypted payload by the CCMP coprocessor.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a diagram of a CCMP encryption/decryption engine according to an embodiment of the disclosure.

FIG. 2 is a diagram of a CCMP encryption/decryption engine according to an alternative embodiment of the disclosure.

FIG. 3 is a diagram of a CCMP encryption/decryption engine according to another alternative embodiment of the disclosure.

FIG. 4 is an illustration of a method for processing a data packet following the CCMP protocol according to an embodiment of the disclosure.

### DETAILED DESCRIPTION OF THE PREFERRED EMBODIMENTS

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein.

Currently, the formation of the nonce and the AADs and the generation of the MIC from the nonce and the AADs are performed entirely in the system hardware or entirely in the system software. In an all-hardware architecture, an algorithm for nonce and AAD formation and MIC generation is fixed for a single wireless standard. This provides a high-speed solution but tends to be inflexible. If a need arises to switch a wireless device from one wireless standard to another, the hardware in the device would typically need to be replaced.

In an all-software configuration, an algorithm for nonce and AAD formation and MIC generation according to a particular wireless standard is stored as an instruction set in a random access memory. This provides a great deal of flexibility since a change from one wireless standard to another would require only the reprogramming of the instruction set from one algorithm to another. However, encryption/decryption and MIC generation would be much slower compared to the all-hardware solution since the encryption/decryption and MIC generation processes are very computational intensive. Therefore, this solution might not be appropriate when a high data transmission rate is needed.

The present disclosure, according to one embodiment, provides a system and method for partitioning the CCMP data security functions into a hardware-based portion and a software-based portion. Functions that remain the same from wireless standard to wireless standard are performed by hardware. Functions that differ from standard to standard are performed by software. This provides the high-speed performance of hardware-based processing while allowing the flexibility of a software-based approach.

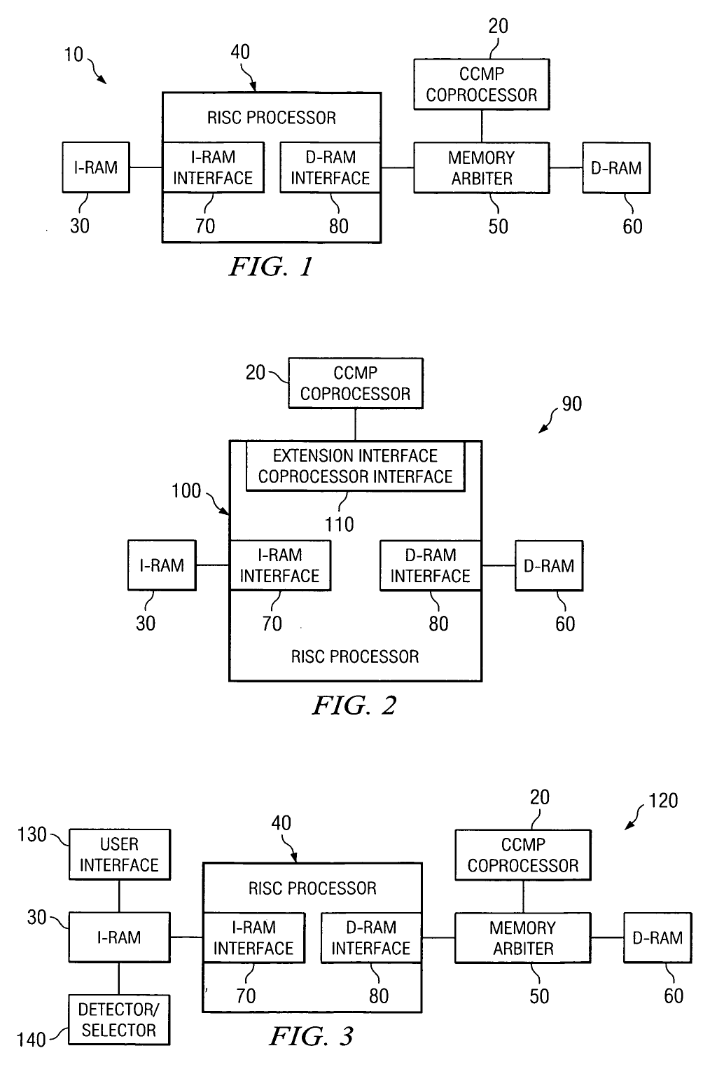

FIG. 1 illustrates a system 10 for implementing the CCMP data security protocol. A CCMP coprocessor 20 handles the CCMP data security functions that remain the same from wireless standard to wireless standard. These functions typically include the encryption and decryption of a data packet payload and the generation of a MIC code.

A reduced instruction set computer (RISC) processor 40 handles the functions that differ from standard to standard. These functions typically include the formation of a nonce and one or more AADs. It should be understood that this component might be a standard central processing unit typically found in wireless data transmission devices and that the RISC processor 40 and the CCMP coprocessor 20 can perform functions in addition to CCMP-related processing.

Software that the RISC processor 40 processes is stored in an instruction RAM (I-RAM) module 30 and is transferred to the RISC processor 40 through an I-RAM interface 70. Data packets that are to be transmitted or that have been received are stored in a data RAM (D-RAM) module 60 and are transferred to the RISC processor 40 through a D-RAM interface 80.

A memory arbiter 50 controls the flow of data between the CCMP coprocessor 20, the RISC processor 40, and the D-RAM 60. The CCMP coprocessor 20 and the RISC processor 40 cannot access the D-RAM 60 at the same time. If the CCMP coprocessor 20 and the RISC processor 40 attempt to access the D-RAM 60 simultaneously, the memory arbiter 50 determines which device is allowed to access the D-RAM 60 first. The memory arbiter 50 also ensures that any processes performed by the CCMP coprocessor 20 and the RISC processor 40 are completed within a minimum number of processor cycles.

As an example of how the system 10 might operate, a data packet in the D-RAM 60 may be prepared to be wirelessly transmitted by a device in which the system 10 is present. In one embodiment, the packet moves from the D-RAM 60, through the memory arbiter 50, through the D-RAM interface 80, into the RISC processor 40. The RISC processor 40 then retains the header portion of the packet and sends the payload portion to the CCMP coprocessor 20.

In another embodiment, the header portion of the packet moves from the D-RAM 60, through the memory arbiter 50, through the D-RAM interface 80, into the RISC processor 40, while the payload portion of the packet moves from the D-RAM 60, through the memory arbiter 50, into the CCMP coprocessor 20. In either embodiment, the RISC processor 40 processes the header portion of the packet and prepares the nonce and AADs and the CCMP coprocessor 20 performs the MIC calculation and the encryption or decryption.

The RISC processor 40 uses data in the header to form the nonce and the AADs (if AADs are required for the data packet) according to software-based instructions retrieved from the I-RAM 30 via the I-RAM interface 70. The instructions direct the nonce and AAD formation according to a particular wireless data transmission standard. The use of the RISC processor 40 to perform a portion of the CCMP protocol places only a small additional burden on the RISC processor 40 and increases the processing time for a data packet only slightly compared to an all-hardware solution. When the nonce and AAD formation are complete, the RISC processor 40 sends the nonce and AADs to the CCMP coprocessor 20.

The CCMP coprocessor 20 calculates the MIC based on the nonce, the AADs, and the payload and then encrypts the payload. These encryption processes are typically the most computationally intensive portions of the CCMP protocol and these processes also tend to be the operations that remain the same from wireless standard to wireless standard. By performing these operations in the fixed hardware of the CCMP coprocessor 20, the system 10 can process data according to the CCMP protocol at a high rate of speed.

The CCMP coprocessor 20 generates a MIC using the nonce and AADs prepared by the RISC processor 40 and the payload of the data packet. The generation of the MIC typically requires an unencrypted payload and, for a packet that is to be transmitted, typically occurs before the encryption of the original payload. For a packet that has been received, the generation of the MIC typically occurs after decryption of the encrypted payload. When the generation of the MIC and the encryption of the payload are complete, the CCMP coprocessor 20 attaches the MIC to the encrypted payload, thus completing the preparation of the packet for wireless transmission. When the packet is received, the MIC is calculated from the nonce, the AADs, and the decrypted payload and is compared with the received MIC to authenticate the received packet.

If, at some future time, a device containing the system 10 needed to transmit data according to a different wireless standard, the I-RAM 30 could simply be reprogrammed with different software that can direct the formation of the nonce and AADs according to the new wireless standard. All other CCMP-based data packet preparation operations as described above would remain the same.

Many of the embedded RISC processors used in typical wireless data communication devices have a limited capacity for handling software-based instructions. However, some RISC processors have the capability to have their instruction-handling capabilities extended to allow additional instructions to be carried out. For example, MIPS offers the CorExtend instruction extension feature for its RISC processors. ARM and other manufacturers offer similar core extension features.

FIG. 2 illustrates an alternative embodiment of a system 90 for implementing CCMP in which a RISC processor 100 has been provided with such an instruction extension feature. The nonce and AAD formation functions as described above are carried out in this core extension. A CCMP coprocessor 20 and the core-extended RISC processor 100 communicate through an extension interface or coprocessor interface 110. With the core extension in place, the RISC processor 100 is able to store instructions for coordinating the movement of data between the RISC processor 100, the CCMP coprocessor 20, and the D-RAM 60; a memory arbiter is not needed. The use of a core extension facilitates the reprogramming of the RISC processor 100 and increases the data encoding efficiency of the system 90.

FIG. 3 illustrates an alternative embodiment of a system 120 for implementing CCMP. In this embodiment, multiple sets of instructions are loaded into the I-RAM 30, with each set capable of directing nonce and AAD formation according to a different wireless standard. Whenever a change occurs in the wireless standard under which the system 120 is operating, rather than the I-RAM 30 being reprogrammed with different instructions, a selection can be made of the appropriate instruction set from the group of instruction sets pre-loaded in the I-RAM 30.

In one embodiment, the selection of the appropriate instruction set is made manually by a user through a user interface 130. In another embodiment, a detector/selector component 140 is present to make the selection automatically. The detector/selector component 140 can automatically determine the wireless standard under which the system 120 is operating and can automatically select the appropriate instruction set for the wireless standard. This detector/selector component 140 may be either software, hardware, or a combination of both.

While both a user interface 130 and a detector/selector component 140 are shown in FIG. 3, in some embodiments only a user interface 130 might be present and in some embodiments only a detector/selector component 140 might be present. Also, while the user interface 130 and the detector/selector component 140 are shown in conjunction with a system such as that in FIG. 1 where a memory arbiter is present, it should be understood that the user interface 130 and/or the detector/selector component 140 might also be used in conjunction with a system such as that shown in FIG. 2 where a core extension is used.

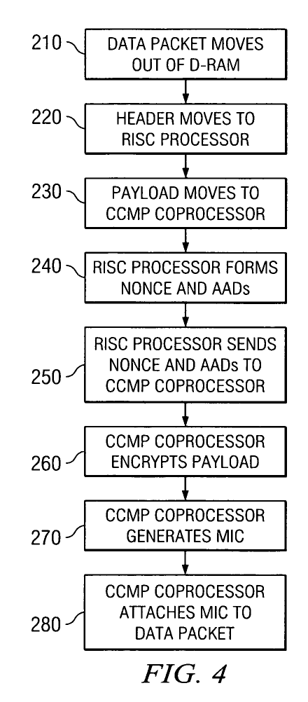

FIG. 4 illustrates an embodiment of a method for following the CCMP protocol for data security. In box 210, a data packet moves out of a data RAM component. In box 220, the header portion of the packet moves to a RISC processor. In box 230, the payload portion of the packet moves to a CCMP coprocessor. In some embodiments, the payload moves from the data RAM to the CCMP coprocessor, while in other embodiments, the payload moves to the RISC processor and then to the CCMP coprocessor.

In box 240, the RISC processor forms a nonce and, if necessary, one or more additional authentication data (AAD) blocks. In box 250, the RISC processor sends the nonce and AADs to the CCMP coprocessor. In box 260, the CCMP coprocessor encrypts the payload. In box 270, the CCMP coprocessor generates a message integrity code (MIC) from the nonce, the AADs, and a portion of the payload data. In box 280, the CCMP coprocessor attaches the MIC to the encrypted payload.

The above steps do not necessarily need to occur in the stated order. Other valid sequences for these events will be apparent to one of skill in the art.

The above discussion has focused on the encryption of a data packet, but it should be understood that similar considerations would apply to data decryption. For example, returning to FIG. 1, a packet to be decrypted might move from the D-RAM 60 to the RISC processor 40. The RISC processor 40 might read the header portion and form a nonce and one or more AADs, which it then sends to the CCMP coprocessor 20. The RISC processor 40 might also send the payload to the CCMP coprocessor 20, where it is decrypted. The CCMP coprocessor 20 might also generate a MIC from the nonce, the AADs, and the decrypted payload. The generated MIC can be compared to the MIC received with the packet to authenticate the packet.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system for processing data packets according to a CCMP protocol, comprising:
a software component operable to form a nonce and AADs according to a CCMP protocol; and
a hardware component operable to receive the nonce and AADs and encrypt a portion of a data packet according to the CCMP protocol.

2. The system of claim 1, wherein the hardware component is further operable to generate a message integrity code based on the nonce, the AADs, and a payload portion of the data packet and to include the message integrity code with the encrypted portion of the data packet.

3. The system of claim 1, further comprising a component operable to control a flow of data between the hardware and software components.

4. A system for processing a data packet according to a CCMP protocol, comprising:
a RISC processor operable to form a nonce and AADs according to a CCMP protocol;
a CCMP coprocessor operable to encrypt at least a portion of the data packet according to a CCMP protocol, the CCMP coprocessor operable to generate a message integrity code based on the nonce, the AADs, and at least a portion of the data packet, and further to provide the message integrity code with the encrypted portion of the data packet;
a data RAM component operable to store the data packet; and
an instruction RAM component operable to store instructions used by the RISC processor for forming the nonce and the AADs.

5. The system of claim 4, wherein the instructions are further defined as software operable to promote the formation of the nonce and the AADs.

6. The system of claim 5, further comprising a memory arbiter operable to control a flow of data from the data RAM to the CCMP coprocessor and the RISC processor.

7. The system of claim 5, further comprising a core extension coupled to the RISC processor, the core extension operable to perform at least a portion of the forming of the nonce and the AADs.

8. The system of claim 7, wherein the RISC processor is operable to control a flow of data from the data RAM to the CCMP coprocessor and the RISC processor.

9. The system of claim 4, wherein the instruction RAM is operable to store a first and a second set of instructions, the first set of instructions used to promote formation of the nonce and the AADs when a first wireless protocol is employed and the second set of instructions used to promote formation of the nonce and the AADs when a second wireless protocol is employed.

10. The system of claim 9, further comprising a user interface operable to allow a user to select one of the first and second sets of instructions to be used in forming the nonce and the AADs depending upon the wireless protocol employed.

11. The system of claim 9, further comprising a detector/selector component operable to automatically determine an appropriate one of the first and second sets of instructions to be used in forming the nonce and the AADs and to automatically cause the appropriate set of instructions to be used.

12. The system of claim 4, wherein the CCMP coprocessor performs processes that are carried out similarly in disparate standards for implementing the CCMP protocol and the RISC processor performs processes that are carried out differently in disparate standards for implementing the CCMP protocol.

13. A method for preparing a data packet for wireless transmission according to a CCMP protocol, comprising:
moving a header portion of the data packet from a data RAM component to a RISC processor;
moving a payload portion of the data packet from the data RAM component to a CCMP coprocessor;
encrypting the payload by the CCMP coprocessor according to the CCMP protocol;
the RISC processor using instructions to form a nonce and AADs according to the CCMP protocol;
sending the nonce and the AADs from the RISC processor to the CCMP coprocessor;
generating a message integrity code by the CCMP coprocessor based on the nonce and the AADs; and
attaching the message integrity code to the encrypted payload by the CCMP coprocessor.

14. The method of claim 13, further comprising controlling a flow of data from the data RAM to the RISC processor and the CCMP coprocessor by means of a memory arbiter.

15. The method of claim 13, further comprising:
loading a first set of instructions to be used by the RISC processor to form a nonce and AADs when a first wireless protocol is employed and loading a second set of instructions to be used by the RISC processor to form a nonce and AADs when a second wireless protocol is employed.

16. The method of claim 13, further comprising storing at least two sets of instructions in an instruction RAM, each set of instructions operable to form the nonce and the AADs in a different manner based on a wireless protocol being used, the at least two sets of instructions being selectable by a user by means of a user interface to choose the manner in which the nonce and the AADs are to be formed.

17. The method of claim 13, further comprising storing at least two sets of instructions in an instruction RAM, each set of instructions operable to form the nonce and the AADs in a different manner based on a wireless protocol being used, the at least two sets of instructions being automatically selectable by a component based on an automatic determination by the component of an appropriate manner in which the nonce and the AADs are to be formed.

18. The method of claim 13, further comprising replacing in an instruction RAM a first set of instructions for forming the nonce and the AADs with a second set of instructions for forming the nonce and the AADs based on which wireless protocol will be used.

19. The method of claim 13, wherein the CCMP coprocessor performs processes that are carried out similarly in disparate standards for implementing the CCMP protocol and the RISC processor performs processes that are carried out differently in disparate standards for implementing the CCMP protocol.

20. The method of claim 19, further comprising a core extension coupled to the RISC processor, the core extension forming at least a portion of the nonce and the AADs.
